(19) United States
(12) Patent Application Publication
(10) Pub. No.: US 2026/0293803 A1
(43) Pub. Date: Oct. 1, 2026

(54) POWER EQUIPMENT WITH SELF-ALIGNING COVER

(71) Applicant: Honda Motor Co., Ltd., Tokyo (JP)

(72) Inventor: Christopher Todd Walker, Hillsborough, NC (US)

(21) Appl. No.: 19/089,972

(22) Filed: Mar. 25, 2025

(51) Int. Cl. A01D 34/81; A01D 101/00

(52) U.S. Cl. CPC A01D 34/81; A01D 2101/00

(57) ABSTRACT

A power equipment includes a battery housing, a cover, and a rib. The battery housing defines an opening to enable access of an inside of the battery housing. The battery housing includes a base defining a groove arranged proximate to the opening. The cover is pivotally coupled to the battery housing and is pivotable between an open position and a closed position. The cover covers the opening of the battery housing in the closed position. The cover includes a first edge and a second edge arranged opposite to the first edge and is pivotally coupled to the battery housing at a location proximate to the first edge. The second edge contacts the base in the closed position of the cover. The rib is attached to the cover, is arranged proximate to the second edge, and is extends inside the groove when the cover is arranged in the closed position.

### BACKGROUND

The disclosed subject matter relates generally to a power equipment, such as lawnmowers, having a battery housing. More particularly, the disclosed subject matter relates to a cover that self-aligns with respect to the battery housing when the cover is moved to a closed position with respect to the battery housing.

Power equipment, such as lawnmowers, hedge trimmers, string trimmers, power saws, tillers, snow blowers, portable coolers, e-bikes, and scooters may be operated by an electric motor, or a hybrid of an internal combustion engine and an electric motor. One or more batteries are generally mounted on the power equipment to supply power to the electric motor. The batteries can be removably mounted onto the power equipment, and are arranged inside a battery housing of the power equipment. Generally, a cover is attached or coupled to the battery housing to cover the battery housing, and the cover is opened, e.g., manually, to access the batteries of the battery housing. In a closed position of the cover, the cover can fail to properly align with the battery housing, potentially leaving gaps for ingress of dust and/or other external elements into the battery housing.

### SUMMARY

In accordance with one embodiment of the present disclosure, a power equipment is provided. The power equipment includes a battery housing, a cover, and at least one rib. The battery housing defines an access opening to enable access of an inside of the battery housing. The battery housing includes a base defining at least one groove arranged proximate to the access opening. The cover is pivotally coupled to the battery housing and adapted to be pivoted between an open position and a closed position. The cover covers the access opening of the battery housing in the closed position. The cover includes a first edge and a second edge arranged opposite to the first edge and is pivotally coupled to the battery housing at a location proximate to the first edge. The second edge is adapted to contact the base in the closed position of the cover. The rib is attached to the cover, is arranged proximate to the second edge, and is configured to extend inside the groove when the cover is arranged in the closed position.

In accordance with another embodiment of the present disclosure, a lawnmower is disclosed. The lawnmower includes a cutter housing, multiple wheels, a blade, a battery housing, a cover, and at least one rib. The cutter housing includes a blade chamber. The wheels are connected to and support the cutter housing. The blade is arranged, at least partially, in the blade chamber and rotatably mounted to the cutter housing to rotate about a blade axis. The battery housing is supported on the cutter housing and defines an access opening to enable an access of an inside of the battery housing. Further, the battery housing includes a base defining at least one groove arranged proximate to the access opening. The cover is pivotally coupled to the battery housing and adapted to be pivoted between an open position and a closed position. The cover covers the access opening of the battery housing in the closed position. The cover includes a first edge and a second edge arranged opposite to the first edge and is pivotally coupled to the battery housing at a location proximate to the first edge. The second edge is adapted to contact the base in the closed position of the cover. The rib is attached to the cover, arranged proximate to the second edge, and configured to extend inside the groove when the cover is arranged in the closed position.

In accordance with yet another embodiment of the present disclosure, a power equipment is disclosed. The power equipment includes a battery housing, a cover, and at least one V-shaped rib. The battery housing defines an access opening to enable an access of an inside of the battery housing. The battery housing includes a base defining at least one V-shaped groove arranged proximate to the access opening. The cover is pivotally coupled to the battery housing and adapted to be pivoted between an open position and a closed position. The cover covers the access opening of the battery housing in the closed position. The cover includes a first edge and a second edge arranged opposite to the first edge and is pivotally coupled to the battery housing at a location proximate to the first edge. The second edge is adapted to contact the base in the closed position of the cover. The V-shaped rib is attached to the cover, arranged proximate to the second edge, and configured to extend inside the at least one V-shaped groove when the cover is arranged in the closed position.

### BRIEF DESCRIPTION OF THE DRAWINGS

Certain embodiments of the present disclosure will be better understood from the following description taken in conjunction with the accompanying drawings in which:

FIG. 1 is a perspective view of a power equipment, in accordance with an embodiment of the present disclosure;

FIG. 2 is a diagrammatic view of the power equipment of FIG. 1 illustrating various internal components of the power equipment, with some exterior portions of the power equipment shown in phantom, in accordance with an embodiment of the present disclosure;

FIG. 3 is an internal view of a battery housing of the power equipment having battery bays to accommodate batteries of the power equipment, in accordance with an embodiment of the present disclosure;

FIG. 4 is another internal view of the battery housing with the batteries removed to reveal the battery bays, in accordance with an embodiment of the present disclosure;

FIG. 5 is an exemplary side cross-sectional view of the battery housing with a cover associated with the battery housing disposed in a partly open position relative to the battery housing, in accordance with an embodiment of the present disclosure;

FIG. 6 is a close-up view of a base of the battery housing depicting a step and a groove formed in the step, in accordance with an embodiment of the present disclosure;

FIG. 7 is a close-up interior view of the cover associated with the battery housing having an exemplary rib attached thereto for an engagement with the groove, in accordance with an embodiment of the present disclosure; and

FIG. 8 is a perspective view of a lid assembly including the cover and illustrating outer confines and various other features associated with the cover, in accordance with an embodiment of the present disclosure.

### DETAILED DESCRIPTION OF EXEMPLARY EMBODIMENTS

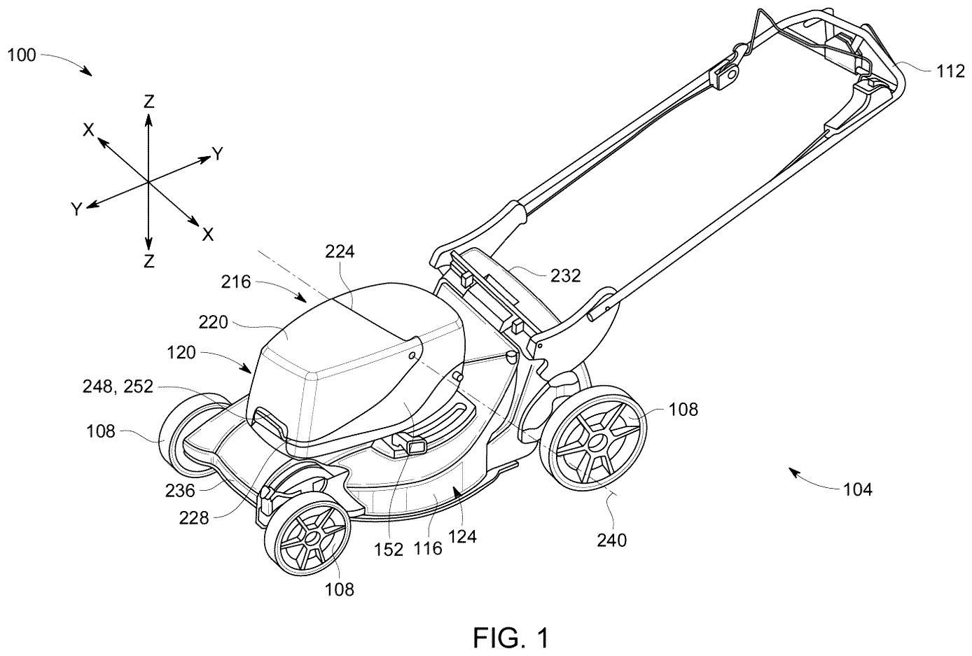

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-8, wherein like numbers indicate the same or corresponding elements throughout the views.

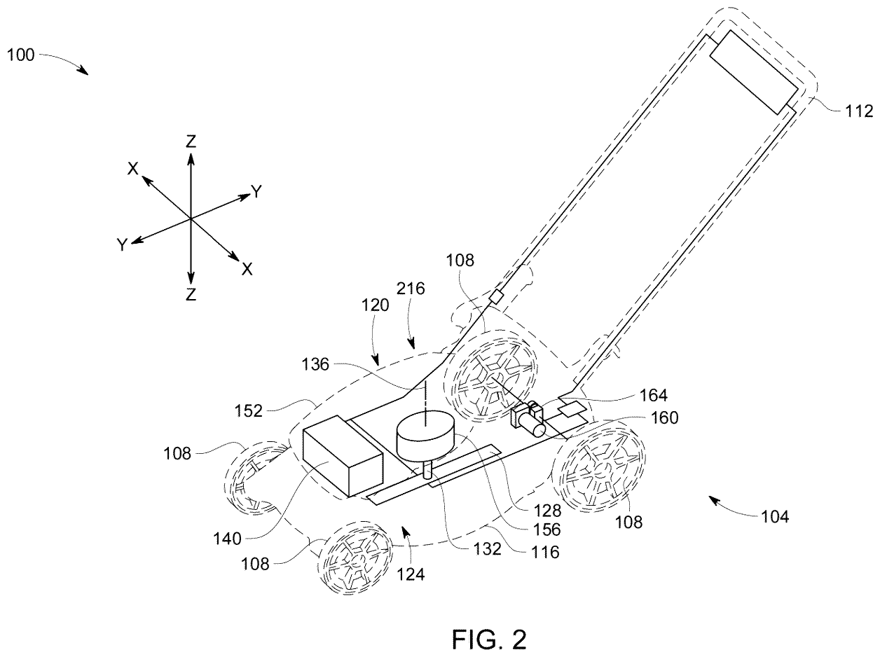

Referring to FIGS. 1 and 2, a power equipment 100, according to an embodiment of the disclosure, is described. In the illustrated embodiment, the power equipment 100 is a lawnmower 104, however, it may be appreciated that the power equipment 100 may include a tiller, a trimmer, a snow blower, a portable cooler, an e-bike, or any other similar equipment known in the art. The power equipment 100 may extend within a space defined along each of an X-direction, a Y-direction, and a Z-direction, as shown, with said directions being orthogonal to each other. The power equipment 100 includes multiple traction members 108, for example, wheels and/or tracks, to enable a movement of the power equipment 100 over a surface. The power equipment 100 can also include a handle 112 to enable a user (not shown) to hold the power equipment 100, e.g., to move the power equipment 100 over the surface.

Referring to FIG. 2, the power equipment 100 includes a cutter housing 116 and a power source assembly 120. The cutter housing 116 includes a blade chamber 124 supported on the traction members 108. Further, a blade 128 is rotatably mounted relative to the cutter housing 116 and is arranged at least partially inside the blade chamber 124. A blade shaft 132 connects the blade 128 with the power source assembly 120. The power source assembly 120 selectively supplies power to rotate the blade shaft 132 (and thus the blade 128) about a blade axis 136, thereby enabling the blade 128 to perform a cutting operation over the surface and accordingly powering the power equipment 100 (and/or the lawnmower 104) for performing useful work. The blade axis 136 extends in the Z-direction, as shown.

The power source assembly 120 may include one or more power sources (e.g., see power source 140) for powering the movement of one or more of the power equipment 100 and/or for rotating the blade 128. The power source 140 can include electrical power sources, such as one or more batteries 144, 148. Further, the power source assembly 120 includes a battery housing 152 for removably arranging the batteries 144, 148 therewithin. Also, the power source assembly 120 may include a blade motor 156 powered by the batteries 144, 148 to provide power (e.g., rotary power) to rotate the blade 128. The power source assembly 120 can also include a propulsion motor 160 powered by the batteries 144, 148 and a transmission 164 operatively connecting the propulsion motor 160 to the traction members 108 (e.g., the rear wheels) to operate the traction members 108 and power the power equipment's movement. In some embodiments, however, the transmission 164 may be omitted.

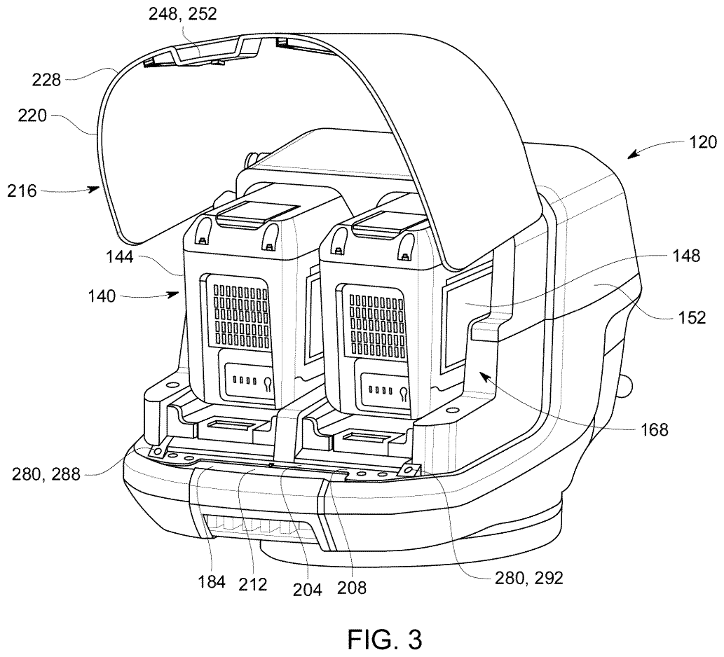

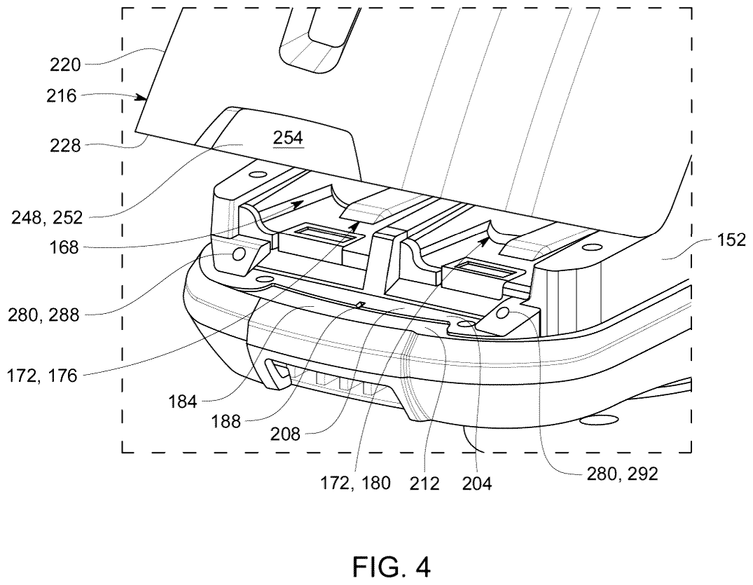

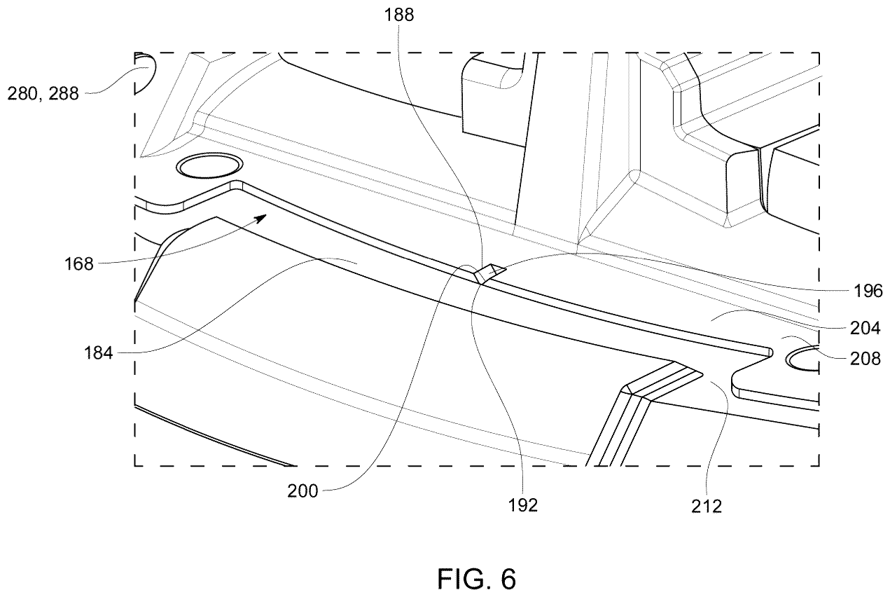

Referring to FIGS. 3 through 7, the battery housing 152 defines an access opening, referred to as an opening 168, to enable access (e.g., to the user) of an inside of the battery housing 152. The battery housing 152 or the inside of the battery housing 152 defines battery bays or receptacles 172 (see FIG. 4) to correspondingly receive the batteries 144, 148. As an example, the battery housing 152 defines two receptacles 176, 180 to correspondingly receive two batteries 144, 148. The battery housing 152 includes a base 184 defining at least one groove 188 arranged proximate to the opening 168. Although not limited, the groove 188 includes a V-shape and defines a groove tip 192 (see FIG. 6) and two groove sidewalls 196, 200 diverging away from each other from the groove tip 192. Other shapes for the groove 188 may be contemplated by someone skilled in the art based on the contents of the present disclosure.

In some embodiments, the groove 188 is arranged on the base 184 centrally to the two receptacles 176, 180. Also, in some embodiments, the base 184 defines a step 204 at a location proximate to the opening 168, as shown. The step 204 may define a stepped surface 208, e.g., raised with respect to a floor 212 of the base 184. In some cases, the groove 188 may be defined and/or formed on the step 204 and may extend through the stepped surface 208 to end at the groove tip 192. In some embodiments, the groove 188 may be representative of one groove and/or of multiple grooves, such as a pair of grooves. Each groove from such a pair of grooves can be similar in structure and form to the groove 188, and, thus, the pair of grooves are neither shown, nor further discussed.

Also, the power equipment 100 includes a lid assembly 216. The lid assembly 216 includes a cover 220 arranged to cover the opening 168 of the battery housing 152. The cover 220 includes a first edge 224 and a second edge 228 (see FIG. 1). The first edge 224 and the second edge 228 may be positioned opposite to each other. More particularly, the first edge 224 is proximate to a rear end 232 of the power equipment 100 and the second edge 228 is proximate to a front end 236 of the power equipment 100 (see FIG. 1). As shown, the first edge 224 of the cover 220 is pivotally coupled to the battery housing 152. In other words, the cover 220 is pivotally coupled to the battery housing 152 at a location proximate to the first edge 224. The pivotal coupling enables the cover 220 to pivot about a pivot axis 240 (see FIG. 1) between an open position and a closed position, e.g., relative to the battery housing 152.

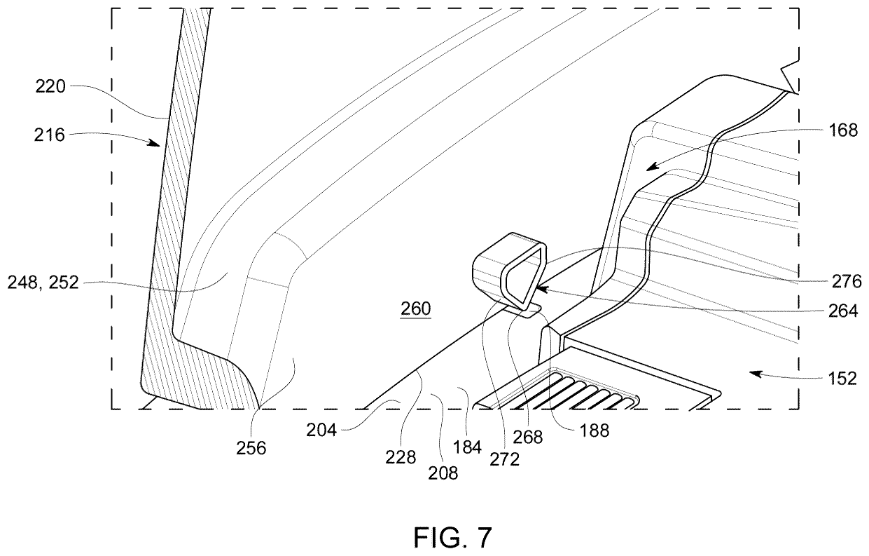

As shown, the pivot axis 240 extends in the X-direction, while the cover 220 extends in the Y-direction to span between the first edge 224 and the second edge 228 and pivot along a plane defined by the X-direction and Z-direction. Moreover, the position of the cover 220 in FIGS. 1 and 7, for example, correspond to a closed position of the cover 220, while the position of the cover 220 in FIG. 3, for example, corresponds to an open position of the cover 220). In the closed position, the cover 220 shields and/or covers the opening 168 of the battery housing 152, while, in the open position, the cover 220 is pivoted and arranged away from the opening 168, thereby providing access to the inside of the battery housing 152 through the opening 168. Further, the second edge 228 of the cover 220 is adapted to contact the base 184 or the step 204 in the closed position of the cover 220.

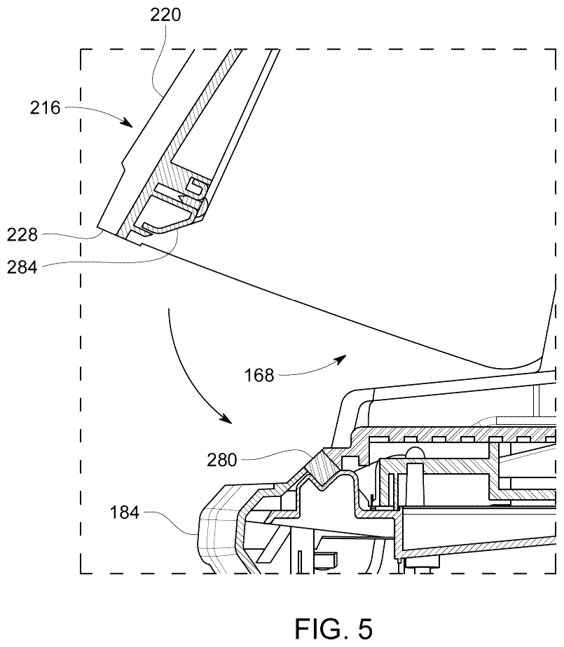

Referring to FIG. 5, and, in some embodiments, the lid assembly 216 may also include a latch (not shown). The latch may be applied to couple and/or lock the cover 220 with the battery housing 152 in the closed position of the cover 220. With the application of the latch, the opening 168 of the battery housing 152 can be retained to be covered (by the cover 220) and thus shielded from the outside elements of the battery housing 152.

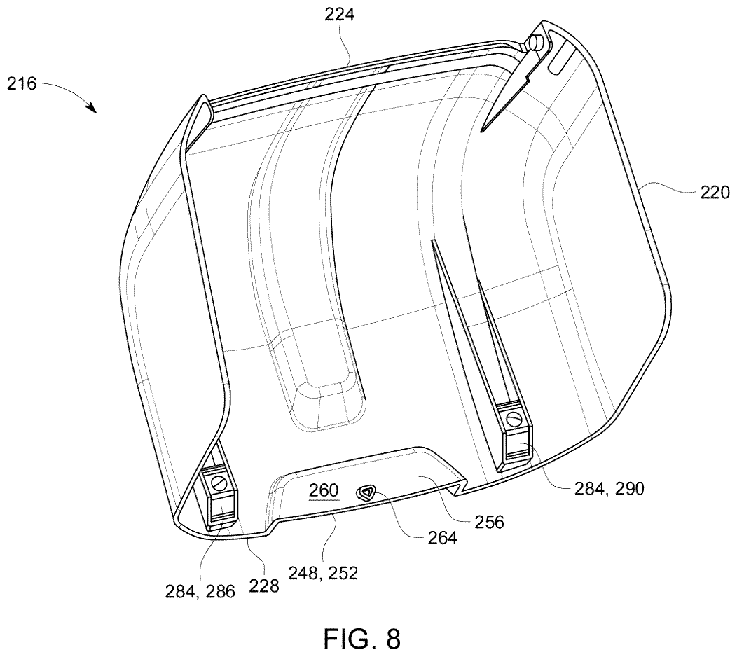

Referring to FIGS. 1, 4, 7, and 8, the lid assembly 216 also includes a handle portion 248. The handle portion 248 may be an indented handle portion 252 that defines a recess 254 (see FIG. 4) at an external face of the cover 220 and a bulge 256 (see FIGS. 7 and 8) at an internal face of the cover 220-the external face is directed to the outside and the internal face is directed to the inside. Accordingly, the indented handle portion 252 and/or the bulge 256 define a bulged out inner surface, or, simply an inner surface 260 (see FIGS. 7 and 8), which is inaccessible to the user from the outside of the battery housing 152 when the cover 220 is in the closed position. The indented handle portion 252 can be engaged by the user (e.g., by having the user's hand inserted into the recess 254) to move the cover 220 between the open position and closed position. In some embodiments, the indented handle portion 252 may also provide a passage to access to an actuation mechanism (not shown) for the latch.

Referring to FIG. 7, the power equipment 100 or the lawnmower 104 includes at least one rib 264. The rib 264 is attached to the cover 220, arranged proximate to the second edge 228, and configured to extend inside the groove 188 when the cover 220 is arranged in the closed position. In some embodiments, the rib 264 is mounted to the inner surface 260 of the indented handle portion 252 of the cover 220 to be attached to the cover 220. As with the groove 188, the rib 264 can include a V-shape and defines a rib tip 268 and two rib sidewalls 272, 276 diverging away from each other from the rib tip 268. For example, the rib 264 includes a first V-shape and the groove 188 includes a second V-shape. The second V-shape can be complementary to the first V-shape such that when the rib 264 is received into the groove 188, the cover 220 is aligned with the battery housing 152. As with the groove 188, in some embodiments, the rib 264 may be representative of one rib or of multiple ribs, such as a pair of ribs. In the case of a single groove (e.g., groove 188) on the base 184, the rib 264 includes a single rib arranged centrally to the second edge 228 and said single groove receives the single rib in the closed position of the cover 220. In the case of a pair of grooves on the base 184, the rib 264 includes a pair of ribs arranged centrally to the second edge 228 and the pair of grooves correspondingly receives the pair of ribs in the closed position of the cover 220.

In some embodiments, magnets 280 (see FIGS. 4 through 6) are attached (e.g., fixedly) to one of the battery housing 152 and the cover 220 and plates 284 (see FIGS. 5 and 8) are attached to the other of the battery housing 152 and the cover 220 to magnetically engage with the magnets 280 in the closed position of the cover 220. By way of magnetic engagement, the cover 220 can be maintained in the closed position with respect to the opening 168 of the battery housing 152. The plates 284 can include metallic plates. In some embodiments, the magnets 280 may include a pair of magnets or two magnets 288, 292 as shown. The two magnets 288, 292 may be attached to the battery housing 152 and/or to the base 184 in proximity to the opening 168. In such a case, the groove 188 can be arranged on the base 184 centrally relative to the two magnets 288, 292. Also, in such a case, the plates 284 may include a pair of plates or two plates 286, 290, as shown in FIG. 8. The two plates 286, 290 can allow the magnets 288, 292 to be correspondingly magnetically engaged thereto, in turn allowing the retention of the cover 220 with the battery housing 152 in the closed position of the cover 220.

During a closure of the cover 220, e.g., after a battery installation process, the cover 220 is pivoted about the pivot axis 240. As the cover 220 is moved towards the closed position, e.g., from the open position, the second edge 228 of the cover 220 nears the base 184 or the step 204, and the rib 264 moves into the groove 188. If at this point, if the cover 220 is improperly aligned with the battery housing 152 or with the opening 168, the rib tip 268 may impinge or rub against at least one of the two groove sidewalls 196, 200, thus aligning (e.g., self-aligning) itself with the battery housing 152 and/or the opening 168. Once the rib tip 268 meets one of the two groove sidewalls 196, 200, the rib 264 may be guided by the corresponding groove sidewall all the way to an end of travel of the cover 220 to the closed position, e.g., till the rib tip 268 meets the groove tip 192. Such concerted action between the rib 264 and the groove 188 enables the cover 220 to be aligned from side to side, e.g., along the X-direction. In some embodiments, in the closed position of the cover 220, the two groove sidewalls 196, 200 may be correspondingly abutted against the two rib sidewalls 272, 276. Such self-aligning feature of the cover 220 with respect to the battery housing 152, and/or the opening 168 of the battery housing 152, ensures magnetic engagement between the magnets 280 and the plates 284 is properly attained and also ensures that a positive mating, fitment, and closure of all gaps, between the cover 220 and the battery housing 152 is positively achieved, thereby sealing and shielding the opening 168 from external elements, such as dust and water, in the closed position of the cover 220.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended that the scope of the disclosure be defined by the claims appended hereto.

What is claimed is:

1. A power equipment, comprising:
a battery housing defining an opening to enable access of an inside of the battery housing, the battery housing includes a base defining at least one groove arranged proximate to the opening;
a cover pivotally coupled to the battery housing and adapted to be pivoted between an open position and a closed position, the cover covering the opening of the battery housing in the closed position, wherein the cover includes a first edge and a second edge arranged opposite to the first edge and is pivotally coupled to the battery housing at a location proximate to the first edge, the second edge is adapted to contact the base in the closed position of the cover; and
at least one rib attached to the cover, arranged proximate to the second edge, and configured to extend inside the at least one groove when the cover is arranged in the closed position.

2. The power equipment of claim 1, wherein the cover includes an indented handle portion defining an inner surface inaccessible when the cover is in the closed position, the at least one rib is mounted to the inner surface to be attached to the cover.

3. The power equipment of claim 1, wherein the battery housing defines two receptacles to correspondingly receive two batteries for powering the power equipment, the at least one groove is arranged on the base centrally to the two receptacles.

4. The power equipment of claim 1, wherein the at least one rib includes a single rib arranged centrally to the second edge and the at least one groove includes a single groove to receive the single rib in the closed position of the cover.

5. The power equipment of claim 1, wherein the at least one rib includes a first V-shape and the at least one groove includes a second V-shape complementary to the first V-shape of the at least one rib such that when the at least one rib is received into the at least one groove, the cover is aligned with the battery housing.

6. The power equipment of claim 1 further comprising
a plurality of magnets attached to one of the battery housing and the cover, and
a plurality of plates attached to the other of the battery housing and the cover, and adapted to magnetically engage with the plurality of magnets in the closed position of the cover.

7. The power equipment of claim 6, wherein the plurality of magnets include two magnets and the plurality of plates correspondingly include two plates, the at least one groove is arranged on the base centrally relative to the two magnets or the two plates.

8. A lawnmower, comprising:
a cutter housing including a blade chamber;
a plurality of wheels connected to and supporting the cutter housing;
a blade arranged, at least partially, in the blade chamber and rotatably mounted to the cutter housing to rotate about a blade axis;
a battery housing supported on the cutter housing and defining an opening to enable an access of an inside of the battery housing, the battery housing includes a base defining at least one groove arranged proximate to the opening;
a cover pivotally coupled to the battery housing and adapted to be pivoted between an open position and a closed position, the cover covering the opening of the battery housing in the closed position, wherein the cover includes a first edge and a second edge arranged opposite to the first edge and is pivotally coupled to the battery housing at a location proximate to the first edge, the second edge is adapted to contact the base in the closed position of the cover; and
at least one rib attached to the cover, arranged proximate to the second edge, and configured to extend inside the at least one groove when the cover is arranged in the closed position.

9. The lawnmower of claim 8, wherein the cover includes an indented handle portion defining an inner surface inaccessible when the cover is in the closed position, the at least one rib is mounted to the inner surface to be attached to the cover.

10. The lawnmower of claim 8, wherein the base defines a step at location proximate to the opening, and the second edge of the cover contacts the step in the closed position of the cover.

11. The lawnmower of claim 8, wherein the battery housing defines two receptacles to correspondingly receive two batteries for powering the lawnmower, the at least one groove is arranged on the base centrally to the two receptacles.

12. The lawnmower of claim 8, wherein
the at least one rib includes a single rib arranged centrally to the second edge and the at least one groove includes a single groove to receive the single rib in the closed position of the cover; and
the single rib includes a first V-shape and the single groove includes a second V-shape complementary to the first V-shape such that when the single rib is received into the single groove, the cover is aligned with the battery housing.

13. The lawnmower of claim 8, wherein the at least one rib includes a pair of ribs and the at least one groove includes a pair of grooves to receive the pair of ribs in the closed position of the cover.

14. The lawnmower of claim 8 further comprising
a plurality of magnets attached to one of the battery housing and the cover, and
a plurality of plates attached to the other of the battery housing and the cover, and adapted to magnetically engage with the plurality of magnets in the closed position of the cover.

15. The lawnmower of claim 14, wherein the plurality of magnets include two magnets and the plurality of plates correspondingly include two plates, the at least one groove is arranged on the base centrally relative to the two magnets or the two plates.

16. A power equipment, comprising:
a battery housing defining an opening to enable an access of an inside of the battery housing, the battery housing includes a base defining at least one V-shaped groove arranged proximate to the opening;
a cover pivotally coupled to the battery housing and adapted to be pivoted between an open position and a closed position, the cover covering the opening of the battery housing in the closed position, wherein the cover includes a first edge and a second edge arranged opposite to the first edge and is pivotally coupled to the battery housing at a location proximate to the first edge, the second edge is adapted to contact the base in the closed position of the cover; and
at least one V-shaped rib attached to the cover, arranged proximate to the second edge, and configured to extend inside the at least one V-shaped groove when the cover is arranged in the closed position.

17. The power equipment of claim 16, wherein the cover includes an indented handle portion defining an inner surface inaccessible when the cover is in the closed position, the at least one V-shaped rib is mounted to the inner surface to be attached to the cover.

18. The power equipment of claim 16, wherein the at least one V-shaped rib includes a single V-shaped rib arranged centrally to the second edge and the at least one V-shaped groove includes a single V-shaped groove to receive the single V-shaped rib in the closed position of the cover.

19. The power equipment of claim 16 further comprising
a plurality of magnets attached to one of the battery housing and the cover, and
a plurality of plates attached to the other of the battery housing and the cover, and adapted to magnetically engage with the plurality of magnets in the closed position of the cover.

20. The power equipment of claim 19, wherein,
the plurality of magnets include two magnets and the plurality of plates correspondingly include two plates, the at least one V-shaped groove is arranged on the base centrally relative to the two magnets or the two plates, and
wherein the battery housing defines two receptacles to correspondingly receive two batteries for powering the power equipment, the at least one V-shaped groove is arranged on the base centrally to the two receptacles.
